(19) United States
(12) Patent Application Publication
(10) Pub. No.: US 2016/0124713 A1
(43) Pub. Date: May 5, 2016

(54) FAST, ENERGY-EFFICIENT EXPONENTIAL COMPUTATIONS IN SIMD ARCHITECTURES

(71) Applicant: International Business Machines Corporation, Armonk, NY (US)

(72) Inventors: Konstantinos Bekas, Horgen (CH); Alessandro Curioni, Gattikon (CH); Yves Ineichen, Zurich (CH); Adelmo Cristiano Innocenza Malossi, Adliswil (CH)

(21) Appl. No.: 14/745,499

(22) Filed: Jun. 22, 2015

Related U.S. Application Data
(63) Continuation of application No. 14/532,312, filed on Nov. 4, 2014.

(51) Int. Cl. G06F 7/483; G06F 9/30

(52) U.S. Cl. CPC G06F 7/483; G06F 9/3001

(57) ABSTRACT

In one embodiment, a computer-implemented method includes receiving as input a value of a variable x and receiving as input a degree n of a polynomial function being used to evaluate an exponential function e^{x}. A first expression A*(x−ln(2)*Kₙ(x_{f}))+B is evaluated, by one or more computer processors in a single instruction multiple data (SIMD) architecture, as an integer and is read as a double. In the first expression, Kₙ(x_{f}) is a polynomial function of the degree n, x_{f} is a fractional part of x/ln(2), A=2⁵²/ln(2), and B=1023*2⁵². The result of reading the first expression as a double is returned as the value of the exponential function with respect to the variable x.

### DOMESTIC PRIORITY

This application is a continuation of U.S. patent application Ser. No. 14/532,312, filed Nov. 4, 2014, the disclosure of which is incorporated by reference herein in its entirety.

### BACKGROUND

Various embodiments of this disclosure relate to exponential computations and, more particularly, to fast and energy-efficient exponential computations in single instruction, multiple data (SIMD) architectures.

Many problems, such as Fourier transforms, neuronal network simulations, radioactive decay, and population grown models, require computation of the exponential function, y=exp(x)=e^{x}, where e is Euler's number and the base of the exponential function. Many problems and applications even require repeated evaluation of the exponential function. To solve these problems efficiently, the exponential function must be solved in a time and energy efficient manner.

Several conventional methods exist to compute the exponential function exactly or approximately. Following are the most widely used approaches, indicating major pros and cons:

One conventional method is by computing the power series. Specifically, y=exp(x) can be written as 1+x+x²/2!+x³/3!+ . . . +xⁿ/n!, with n being an integer no less than 1. A positive aspect of this method is that the accuracy of the exponential function can be controlled by varying the value of n. At the limit, i.e., as n approached infinity, the sum converges to the exact value of the exponential function. A drawback of this method is that this implementation is inefficient, since convergence is slow for an increasing value of n. Even using Homer's method, this requires too many floating-point multiply-add operations to obtain a desired accuracy, unless the range of values of x is limited and known in advance.

A second class of conventional methods uses lookup tables. The exponential is converted in a base-2 expression and subsequently decomposed into its integer part xᵢ and fractional part x_{f}, i.e., y=exp(x)=2^{x*log2(e)}=2^{x}^{ᵢ}^{+x}^{_{f}}. One or more lookup tables are then used to evaluate 2^{x}^{ᵢ} and 2^{x}^{ᵢ} separately, where x_{f} is defined in the range [0,1), i.e., greater than or equal to 0 and less than 1. This method is faster than the power series method given above. However, the lookup tables do not exploit floating-point arithmetics.

Another conventional method manipulates the standard IEEE-745 (from the Institute of Electrical and Electronics Engineers) floating-point representation to approximate the exponential using the floating-point number representation (−1)^{s}*(1+m)*2^{x-x0}, where s is the sign bit, m the mantissa (i.e., a binary fraction in the range [0, 1)), and x0 is the constant bias shift. In brief, the method requires shifting the exponent by the number of bits required to obtain the integer part of the exponential (i.e., 2^{x}^{ᵢ}), and then approximating the fractional part 2^{x}^{_{f}} with (1+m). The resulting arithmetic is simple and consists of a single floating-point multiply-add, specifically y=A*x+C, where A and C are pre-computed constants. This is the fastest known approach to obtain an approximation of the exponential function, but the accuracy is low, at only a single digit.

Even though the above exponential function evaluation methods exist, none of them provides sufficient accuracy as well as time and energy efficiency.

### SUMMARY

In one embodiment of this disclosure, a computer-implemented method includes receiving as input a value of a variable x and receiving as input a degree n of a polynomial function being used to evaluate an exponential function e^{x}. A first expression A*(x−ln(2)*Kₙ(x_{f}))+B is evaluated, by one or more computer processors in a single instruction multiple data (SIMD) architecture, as an integer and is read as a double. In the first expression, Kₙ(x_{f}) is a polynomial function of the degree n, x_{f} is a fractional part of x/ln(2), A=2⁵²/ln(2), and B=1023*2⁵². The result of reading the first expression as a double is returned as the value of the exponential function with respect to the variable x.

In another embodiment, a system includes a memory and one or more processor cores communicatively coupled to the memory. The one or more processor cores are configured to receive as input a value of a variable x and a degree n of a polynomial function being used to evaluate an exponential function e^{x}. The one or more processor cores are further configured to evaluate, in a single instruction multiple data (SIMD) architecture, a first expression A*(x−ln(2)*Kₙ(x_{f}))+B as an integer and to read the first expression as a double. In the first expression, Kₙ(x_{f}) is a polynomial function of the degree n, x_{f} is the fractional part of x/ln(2), A=2⁵²/ln(2), and B=1023*2⁵². The one or more processor cores are further configured to return, as the value of the exponential function with respect to the variable x, the result of reading the first expression as a double.

In yet another embodiment, a computer program product for evaluating an exponential function includes a computer readable storage medium having program instructions embodied therewith. The program instructions are executable by a processor to cause the processor to perform a method. The method includes receiving as input a value of a variable x and receiving as input a degree n of a polynomial function being used to evaluate an exponential function e^{x}. A first expression A*(x−ln(2)*Kₙ(x_{f}))+B is evaluated, by one or more computer processors in a single instruction multiple data (SIMD) architecture, as an integer and is read as a double. In the first expression, Kₙ(x_{f}) is a polynomial function of the degree n, x_{f} is a fractional part of x/ln(2), A=2⁵²/ln(2), and B=1023*2⁵². The result of reading the first expression as a double is returned as the value of the exponential function with respect to the variable x.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a computation system, according to some embodiments of this disclosure;

FIG. 2 is a flow diagram of a method for computing an exponential function, according to some embodiments of this disclosure;

FIG. 3 illustrates representations of some variables used in evaluating the exponential function, according to some embodiments of this disclosure; and

FIG. 4 is a block diagram of a computing device for implementing some or all aspects of the computation system, according to some embodiments of this disclosure.

### DETAILED DESCRIPTION

Various embodiments of this disclosure are computation systems for computing the exponential function in a time and energy efficient manner. Some computation systems according to this disclosure may use double-precision architectures, i.e., a variable x is defined in the approximate interval [−746, 710] to respect the IEEE limits. However, some alternative embodiments are adaptable without major modifications to arbitrary and variable precision arithmetic architectures, e.g., single-precision, quadruple-precision, graphics processing units (GPUs), field-programmable gate arrays (FPGAs), etc. In some embodiments, in the case of streams of exponentials, the computation system may enable the use of only SIMD instructions, while conventional mechanisms for computing the exponential require various non-vectorizable operations. As a result, the present computation system may improve performance as compared to conventional systems and, at the same time, reduce energy consumption.

Embodiments of the computation system may work on various SIMD architectures, e.g., IBM® AltiVec or Intel® Streaming SIMD Extensions (SSE). Each distinct SIMD architecture may implement vector instructions in a particular way, according to the architecture, but the functionality of the computation system may be the same or similar across SIMD architectures. Thus, references to SIMD architectures throughout this disclosure may encompass various types of architectures that implement vector instructions, and reference to vector instructions in this disclosure may encompass various implementations of these instructions regardless of the architecture being used.

Although some conventional methods exist for computing the exponential function, none of them is able to leverage the SIMD capabilities of modern architectures and, at the same time, provide sufficient accuracy. According to this disclosure, however, the present computation system may accurately compute the exponential function, while using vector instructions in some or all computational steps, thus attaining an optimal or improved hardware utilization.

In some embodiments, the computation system may combine manipulation of the standard IEEE-745 floating-point representation (as proposed in N. N. Schraudolph; A Fast, Compact, Approximation of the Exponential Function; Neural Computation 11(4), 853-862, 1999 (hereinafter “Schraudolph”) and G. C. Cawley; On a Fast, Compact Approximation of the Exponential Function; Neural Computation 12(9), 2009-2012, 2000) with a polynomial interpolation (e.g., Chebyshev polynomials of the first kind or Remez polynomials) of the fractional part 2^{x}^{_{f}}. In some embodiments, the resulting algorithm can be written in a compact form relying on only SIMD instructions. The computation system may thus provide a fast and energy-aware implementation of the exponential function, well suited for state-of-the-art architectures, mobile devices, laptops, desktop servers, cloud systems, and supercomputers, for example.

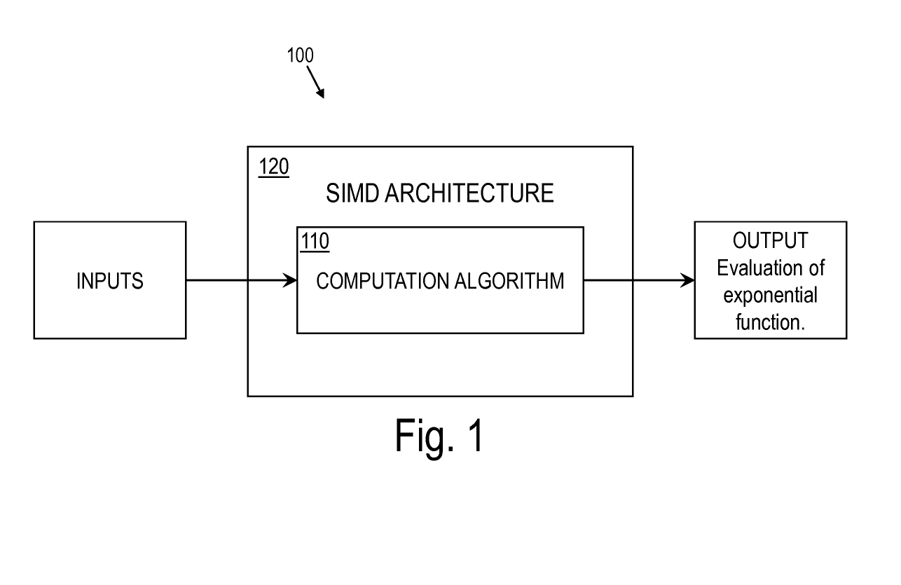

FIG. 1 is a block diagram of a computation system 100, according to some embodiments of this disclosure. As shown, the computation system 100 may take as input a value of the exponent x as well as a degree n of the polynomial Kₙ(x_{f}). The computation system 100 may process these inputs using a computation algorithm 110 executed on an SIMD architecture 120. Thus, at the cost of a single cycle, multiple independent operations may be performed in parallel, and the results of such operations may be used in the following cycle. As a result of applying the computation algorithm 110 on an SIMD architecture 120, the computation system 100 may compute an approximate value of the exponential function. Details of the computation algorithm 110 will be described in more detail below.

The value of x received as input may be a scalar or a vector, where the vector may be a set of one or more values. If x is a vector, the computation system 100 may evaluate the exponential function with respect to all values within the vector x, and this evaluation may be performed in parallel. If x is a scalar, SIMD instructions need not be used, as no parallel evaluation is required. However, in that case, embodiments of the present computation system 100 may still outperform conventional mechanism for evaluating the exponential function.

Embodiments of the computation system 100 may build upon and significantly extend the strategy in Schraudolph, to obtain an accurate approximation of the exponential function. Equation 1 in Schraudolph reads i=A*x+B−C, with A=2²⁰/ln(2), B=1023*2²⁰, and C=60801, where 2²⁰ is the shift associated with single-precision floating point numbers, 1023 is the bias factor for double-precision floating point numbers, C is a correction coefficient that minimizes the root-mean-square (RMS) relative error, and i is an integer. The main idea behind the strategy in Schraudolph is that reading the integer i as a double-precision number produces int2double(A*x+B−C)=(−1)^{s}*(1+*2^{x}^{ᵢ}≈exp(x), where int2double is an operator that reads an integer as a double. The sign bit (−1)^{s}=1 may be ignored because the exponential function always returns positive numbers by definition.

While the above strategy is fast, it leads to an inaccurate approximation, i.e., approximately one digit correctness. To recover good accuracy, without compromising the performance, embodiments of the computation system 100 herein may make some or all of the following modifications: (1) Move the entire operation to double-precision, replacing the shift factor with 2⁵². Along with the shift factor, the values of A and B may be modified accordingly, with A=2⁵²/ln(2), B=1023*2⁵². In other words, the values of A and B may be set as A=S/ln(2), B=1023*S, where S represents the shift factor. (2) Use a long int for i instead of the two contiguous integers used in Schraudolph. This may simplify the conversion to double, and may leverage the 52 digits of the double-precision mantissa. The terms “int” and “long int,” as used herein, refer to variable types for integer and long integer, respectively. (3) Set C=0, because this constant may become useless due to the other modifications. (4) Define the following equality: exp(x)=2^{x}^{ᵢ}*2^{x}^{_{f}}≈(1+m−K)*2^{x}^{ᵢ}, where xᵢ and x_{f} are, respectively, the integer and fractional part of x/ln(2), and K is a correction to the mantissa that aims to improve the exponential approximation. (5) Solve the previous equation for K, obtaining K=1+m−2^{x}^{_{f}}. Moreover, it is noted that m=x_{f}, such that K(x_{f})=1+x_{f}−2^{x}^{_{f}}, which is an analytical function of the fractional part x_{f}, with x_{f} defined in the limited domain [0,1). (6) Model the function K(x_{f}) with a polynomial Kₙ(x) in the form Kₙ(x_{f})=a*x_{f}ⁿ+b*x_{f}ⁿ⁻¹+c*x_{f}ⁿ⁻², where n denotes the order of the polynomial interpolation. In some embodiments, the coefficients {a, b, c, . . . } are pre-computed according to the chosen polynomial interpolation. Among the several possible choices, good options may include the Chebyshev polynomial and the Remez polynomial. The latter may minimize the infinity norm of the error. Further, the previous expression for Kₙ(x) may be manipulated using Horner's rule, leading to a complexity of a floating-point multiply-add for each degree of the polynomial. This operation is well suited for a subsequent SIMD vectorization. (7) Plug the resulting polynomial into the original expression, i.e., exp(x)≈int2double(A*(x−ln(2)*Kₙ(x_{f}))+B).

In some embodiments, some of the operations (1), (2), (3), (4), (5), and (6) above, which describe a procedure to arrive to Kₙ, need not be performed before operation (7). Rather, for each value of n, the computation system 100 may include a distinct code implementation, and as a result, the value of n is used to select a polynomial function and need not be passed as a variable to the polynomial function. This selection may be performed at various times, for example, before the evaluation of the exponential function begins (i.e., the value of n is decided a priori) or during the evaluation, in which case n may behave as an input parameter in the classical sense.

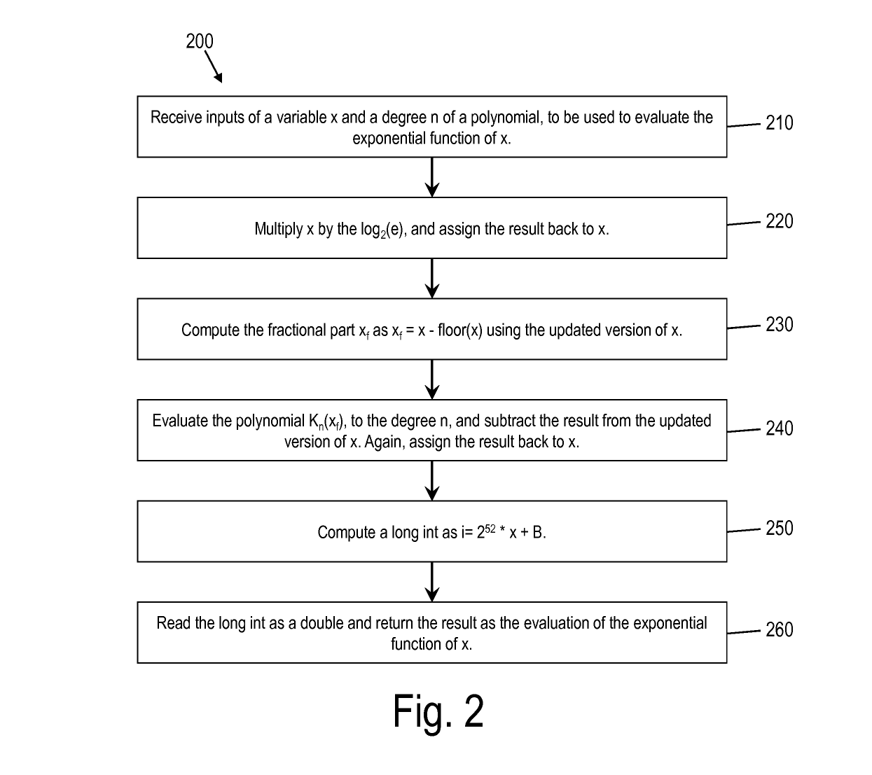

More specifically, FIG. 2 is a flow diagram of a method 200 for computing the exponential function, according to some embodiments of this disclosure. This method 200 may be used for the computation algorithm 110 of FIG. 1. It will be understood that FIG. 2 is provided for illustrative purposes only, and that other methods may also be within this scope of this disclosure. The method 200 may take as inputs, at block 210, a value of x, and a degree n of the polynomial Kₙ(x_{f}). The method 200 may output, at block 270, an approximate evaluation of the exponential function according to the chosen degree of the polynomial.

In some embodiments, the variable x may be provided as a double, in which case the variable i may be a long int, as described below. Alternatively, however, in some embodiments, x may be a float, and i may be an int. The variable types referred to herein (e.g., double, float, long int, and int) are based on a traditional C/C++ notation. One skilled in the art will understand that other languages may refer to these types using other names. For example, in FORTRAN, a float would be referred to as a real. In addition, in some embodiments, other variable bit length representations may be used to represent the variables x and i.

The variable x may be a scalar or a vector (e.g., a vector of doubles or floats). If x is a vector, the approximate evaluation of the exponential function may include an evaluation for each value in the vector x. In that case, some or all operations in the above method 200 may be implemented as SIMD vector instructions. In other words, multiple exponential functions may be evaluated in parallel, with a current block of FIG. 2 being performed for the multiple exponential functions at a given time. In conventional mechanism for evaluating the exponential function, at least one operation cannot be performed with an SIMD instruction. As a result, these conventional mechanisms require a cycle to process each value in the vector x separately, which creates a bottleneck even if the rest of the method used is SIMD vectorizable.

At block 220, the input x may be multiplied with the coefficient log₂(e). In some embodiments, the result may be stored back in the variable x, which is assumed to be the case for the remaining blocks of this method 200. However, it will be understood that re-using the variable x in this manner is not required, and that another variable may replace x in the remaining blocks of this method 200 if the variable x is not reused. It should be noted that, in Schraudolph, x is divided by ln(2) instead of the above, which leads to the same result but with the increased cost of a division.

At block 230, the fractional part x_{f} may be computed. Because the value of x was updated in block 220, x_{f} may be computed as x_{f}=x−floor(x). The use of the floor function, in contrast with rounding, may result in a correct evaluation for negative exponents as well as positive ones. In some embodiments, the computation system 100 may use IEEE binary manipulations to extract the value of x_{f} from x without using the floor(x) function.

At block 240, the function Kₙ(x_{f}), which is a polynomial to the degree n, may be evaluated and subtracted from x. Once again, the result of this operation may be stored back in the variable x (i.e., x=x−Kₙ(x_{f})), which is assumed to be the case in the remaining blocks of the method 200. In block 240, evaluation of the polynomial Kₙ(x_{f}) may be performed with an SIMD instruction for each degree of n, where each multiply-add operation is a distinct SIMD instruction. Further, in some embodiments, the coefficients of the polynomial Kₙ(x_{f}), as well as A, B, and other necessary constants, may be pre-computed, prior to beginning the parallel evaluation of the exponential function for x.

At block 250, the long int i may be computed as i=2⁵²*x+B. For example, and not by way of limitation, in the C++ programming language, this can be performed as a static_cast<long int>, which is an SIMD-vectorizable instruction.

At block 260, the long int i may be read as a double, and at block 270, its value may be returned as the approximated exponent. In C++, this may be performed as a reinterpret_cast<double &>, which is an SIMD-vectorizable instruction.

In some embodiments, blocks 240, 250, and 260 may be joined in a single code line to assist the subsequent optimization process by the compiler. This combination may reduce or minimize the number of temporary variables used, even though the compiler can decide to reintroduce variables. In some embodiments, execution may be improved by implementing the exponential function directly in assembly code. Although modern compilers do a good job of optimizing code, an assembler version may allow a precise accountability of used instructions.

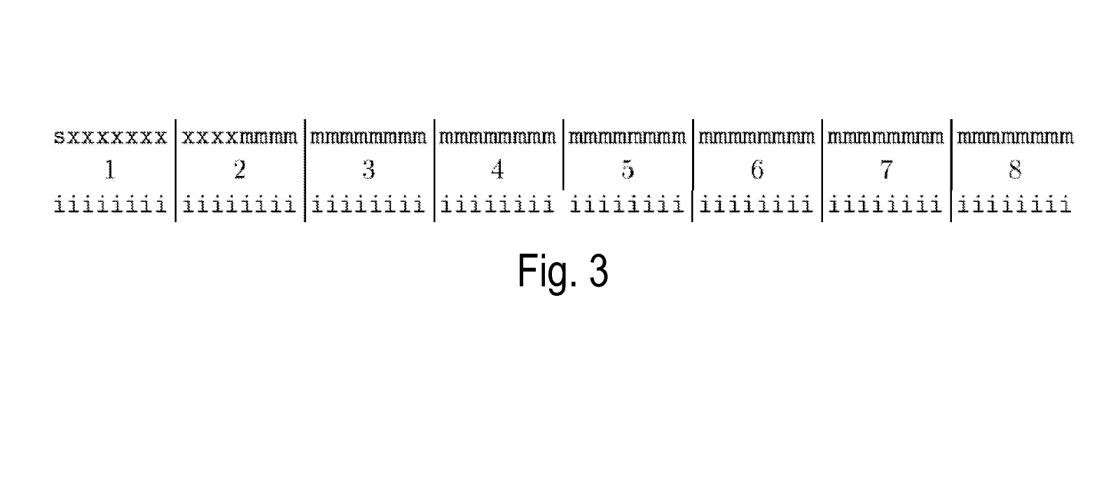

FIG. 3 illustrates a representation of a variable i, used in evaluating the exponential function, according to some embodiments of this disclosure. FIG. 3 shows two horizontal lines, each including 64 characters that represent bits, further grouped into 8 bytes. Each of these bits has a value of either 0 or 1. The top line represents the bits of the value of an exponential function, as evaluated by an embodiment of the computation system 100, represented as a double. The bottom line represents the bits of the variable i, represented as a long integer. When read as a double, this variable i results in the value of the exponential function given in the top line.

The top line of FIG. 3 may represent the double whose value is the evaluated exponential function, i.e., the output value. More specifically, the first bit may be interpreted as the sign bit s. The next 11 bits may represent the value of xᵢ, and the 52 bits following those may represent the value of the mantissa m.

The second line may represent the long integer i. Schraudolph uses two integers of 32 bits each, i and j. Instead, some embodiments of the computation system 100 use a single long integer that is represented by 64 bits, as shown. In an IEEE manipulation, the long integer i may be calculated using the expression i=A*x+B−C, and the computation system 100 may subsequently interpret the resulting line as if it were a double, using int2double0. Thus, in reading the variable i as a double, the first bit from the left in the integer line may be read as the sign s; the next 11 digits may be read as the variable x; and remainder of the line may be read as the mantissa m. The result may be value of the exponential function shown on the top line.

Various advantages exist in embodiments of the present computation system 100, as opposed to conventional mechanisms for computing the exponential function. Seven of such potential advantages are described below, some or all of which may be present in a particular embodiment.

The user can control the accuracy of the exponential function by selecting an appropriate degree of the polynomial approximating 2^{x}^{_{f}}. The accuracy can be specified in advance at compile time or, alternatively, at run time. In the latter case, the accuracy may be tuned, for example, to the basis of the current residual norm of an iterative solver or an imposed tolerance.

The computation system may be based on a pure SIMD implementation. In other words, some or all the instructions used by the computation system 100 to evaluate the exponential function may be vectorized or vectorizable. In some embodiments, all of such instructions may be vectorized or vectorizable, without exception, regardless of the specific SIMD architecture being used.

Compared with existing mechanisms, the computation system 100 may drastically reduce the time-to-solution. In practice, the reduction has been up to approximately 96% on BG/Q and POWER7 architectures. Similar performances are expected on other architectures, such as IBM POWER8 or Intel®, for example. Compared to existing mechanisms, the computation system 100 may provide a significant reduction in the energy-to-solution. In practice, this reduction has been quantified in up to approximately 93% on BG/Q and POWER7 architectures.

In scalar versions of the computation system 100, in which only one exponential is evaluated at each call and thus SIMD instructions are not applicable, the computation system 100 may provide a sensible reduction in the time-to-solution (e.g., 10% and 50% on BG/Q and between 75% and 90% on POWER7), as well as in energy-to-solution (e.g., between 10% and 60% on BG/Q and between 65% and 90% on POWER7).

In some embodiments, performances of the SIMD version need not downgrade significantly when the vector size is not divisible by the SIMD factor (e.g., 4 on BG/Q and 2 on POWER7).

Further, an OpenMP implementation may be used to further improve the time-to-solution and the energy-to-solution in the case of big vectors (e.g., vectors that do not fit the lower cache levels).

It will be understood that the above examples of advantages over conventional mechanisms for computing the exponential function is not limiting. Rather, other advantages over the conventional art may also exist in some embodiments of this disclosure.

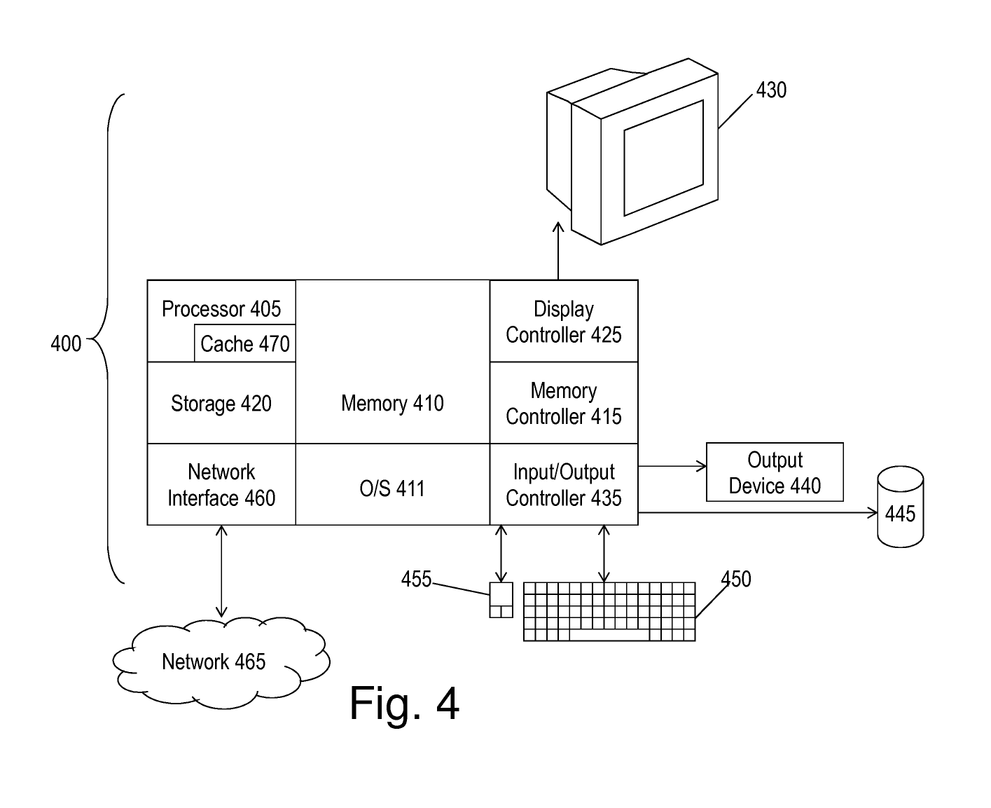

FIG. 4 illustrates a block diagram of a computer system 400 for use in implementing a computation system or method according to some embodiments. The computation systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 400, such as a personal computer, workstation, minicomputer, mainframe computer, or mobile system (e.g., a smartphone or tablet). For example, and not limitation, the computer system 400 may have an SIMD architecture configured to implement a computation system 100 according to this disclosure.

In an exemplary embodiment, as shown in FIG. 4, the computer system 400 includes a processor 405, memory 410 coupled to a memory controller 415, and one or more input devices 445 and/or output devices 440, such as peripherals, that are communicatively coupled via a local I/O controller 435. These devices 440 and 445 may include, for example, a printer, a scanner, a microphone, and the like. A conventional keyboard 450 and mouse 455 may be coupled to the I/O controller 435. The I/O controller 435 may be, for example, one or more buses or other wired or wireless connections, as are known in the art. The I/O controller 435 may have additional elements, which are omitted for simplicity, such as controllers, buffers (caches), drivers, repeaters, and receivers, to enable communications.

The I/O devices 440, 445 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 405 is a hardware device for executing hardware instructions or software, particularly those stored in memory 410. The processor 405 may be any custom made or commercially available processor, a central processing unit (CPU), an auxiliary processor among several processors associated with the computer system 400, a semiconductor based microprocessor (in the form of a microchip or chip set), a macroprocessor, or other device for executing instructions. The processor 405 includes a cache 470, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 470 may be organized as a hierarchy of more cache levels (L1, L2, etc.).

The memory 410 may include any one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 410 may incorporate electronic, magnetic, optical, or other types of storage media. Note that the memory 410 may have a distributed architecture, where various components are situated remote from one another but may be accessed by the processor 405.

The instructions in memory 410 may include one or more separate programs, each of which comprises an ordered listing of executable instructions for implementing logical functions. In the example of FIG. 4, the instructions in the memory 410 include a suitable operating system (OS) 411. The operating system 411 essentially may control the execution of other computer programs and provides scheduling, input-output control, file and data management, memory management, and communication control and related services.

Additional data, including, for example, instructions for the processor 405 or other retrievable information, may be stored in storage 420, which may be a storage device such as a hard disk drive or solid state drive. The stored instructions in memory 410 or in storage 420 may include those enabling the processor to execute one or more aspects of the computation systems and methods of this disclosure.

The computer system 400 may further include a display controller 425 coupled to a display 430. In an exemplary embodiment, the computer system 400 may further include a network interface 460 for coupling to a network 465. The network 465 may be an IP-based network for communication between the computer system 400 and any external server, client and the like via a broadband connection. The network 465 transmits and receives data between the computer system 400 and external systems. In an exemplary embodiment, the network 465 may be a managed IP network administered by a service provider. The network 465 may be implemented in a wireless fashion, e.g., using wireless protocols and technologies, such as WiFi, WiMax, etc. The network 465 may also be a packet-switched network such as a local area network, wide area network, metropolitan area network, the Internet, or other similar type of network environment. The network 465 may be a fixed wireless network, a wireless local area network (LAN), a wireless wide area network (WAN) a personal area network (PAN), a virtual private network (VPN), intranet or other suitable network system and may include equipment for receiving and transmitting signals.

Computation systems and methods according to this disclosure may be embodied, in whole or in part, in computer program products or in computer systems 400, such as that illustrated in FIG. 4.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving as input a value of a variable x;
receiving as input a degree n of a polynomial function being used to evaluate an exponential function e^{x};
evaluating, by one or more computer processors in a single instruction multiple data (SIMD) architecture, a first expression A*(x−ln(2)*Kₙ(x_{f}))+B as an integer and reading the first expression as a double, wherein Kₙ(x_{f}) is a polynomial function of the degree n, x_{f} is a fractional part of x/ln(2), A=2⁵²/ln(2), and B=1023*2⁵²; and
returning, as the value of the exponential function with respect to the variable x, the result of reading the first expression as a double.

2. The method of claim 1, further comprising evaluating the exponential function using SIMD parallelism for two or more values of the variable x.

3. The method of claim 1, wherein the evaluating comprises computing x_{f} by, in a first SIMD instruction, multiplying the value of x by log₂(e) to produce a first temporary result and by, in a second SIMD instruction, subtracting from the first temporary result the floor of the first temporary result.

4. The method of claim 3, wherein the evaluating comprises, in one or more additional SIMD instructions, evaluating the polynomial Kₙ(x_{f}) to produce a second temporary result and subtracting the second temporary result from the first temporary result to product a third temporary result, wherein the one or more additional SIMD instructions comprise an SIMD instruction for each degree of the polynomial Kₙ(x_{f}).

5. The method of claim 4, wherein the evaluating comprises, in a fourth SIMD instruction, computing a long integer as 2⁵²+B.

6. The method of claim 5, wherein reading the first expression as a double comprises reading the long integer as a double.
